(19) United States
(12) Patent Application Publication
(10) Pub. No.: US 2026/0072867 A1
(43) Pub. Date: Mar. 12, 2026

(54) FABRIC SCALE-UP FOR WAFER-SCALE PLATFORMS

(71) Applicant: Intel Corporation, Santa Clara, CA (US)

(72) Inventors: William BUTERA, West Newton, MA (US); Sari COUMERI, West Newton, MA (US); Carl BECKMANN, Concord, MA (US); Simon C. STEELY, JR., Hudson, NH (US)

(21) Appl. No.: 19/388,272

(22) Filed: Nov. 13, 2025

(51) Int. Cl. G06F 15/78

(52) U.S. Cl. CPC G06F 15/7896

(57) ABSTRACT

Examples described herein relate to a device that includes: a plurality of nodes, wherein a node of the plurality of nodes comprises at least one processor and a structure comprising multiple physical layers, wherein different physical layers of the multiple physical layers are to provide communication entry points to at least some of the same nodes at different node spans by a stack of overlapping two dimensional (2D) meshes. In some examples, a first layer of the multiple layers comprises a first trace that comprises a link that connects a first span of nodes. In some examples, a second layer of the multiple layers comprises a second trace that comprises a link that connects a second span of nodes, where the first span of nodes is greater than the second span of nodes.

High Performance Computing (HPC) aggregates multiple computers into clusters for solving compute-intensive problems at high speeds. HPC systems may be built using multi-tile processors, e.g. integrated circuits (ICs) with multiple processor tiles. A processor tile may include a computing element, a processor core, a core, a processing engine, an execution unit, a central processing unit (CPU), caches, switches, and other components. A tile may be coupled to one or more neighboring tiles by at least one interface.

However, scaling up 2D mesh interconnects faces several constraints. A first constraint is an increase in latency, and the attendant drop in bandwidth at network endpoints. A second constraint is an increase in aggregate energy consumed by a packet as it transits elongated signal paths.

### BRIEF DESCRIPTION OF THE DRAWINGS

FIG. 1 depicts an example relationship between capacity and mesh dimensions.

FIG. 2 depicts an example peak sustained bandwidth as seen by each terminal element in the network.

FIG. 3 depicts data movement in an example composite mesh.

FIG. 4 depicts an example interconnect pattern in a 3-level hierarchy of 2D meshes, and an example chiplet arrangement.

FIG. 5 depicts an example of express mesh signal paths in a 4-layer reticle.

FIG. 6 depicts an example of a reticle trace placement and channel definition.

FIG. 7A depicts a block diagram for a sample architecture of a disaggregated router.

FIG. 7B depicts an example of terminal locations.

FIG. 8 depicts the signal path for a sample routing algorithm.

FIG. 9 depicts a sample component organization for a System-in-Package CPU server for the AI data center.

FIG. 10 depicts sample “stacked memory” component organization for AI accelerator in a super-carrier socket.

FIG. 11 depicts an example of latency and throughput measurements on a 32×32 array of endpoints.

FIG. 12 depicts an example of latency and throughput measurements on a 64×64 array of endpoints.

FIG. 13 depicts an example of throughput versus injection rate for a tunable routing function.

FIGS. 14A and 14B depict example processes.

FIG. 15 depicts a system.

### DETAILED DESCRIPTION

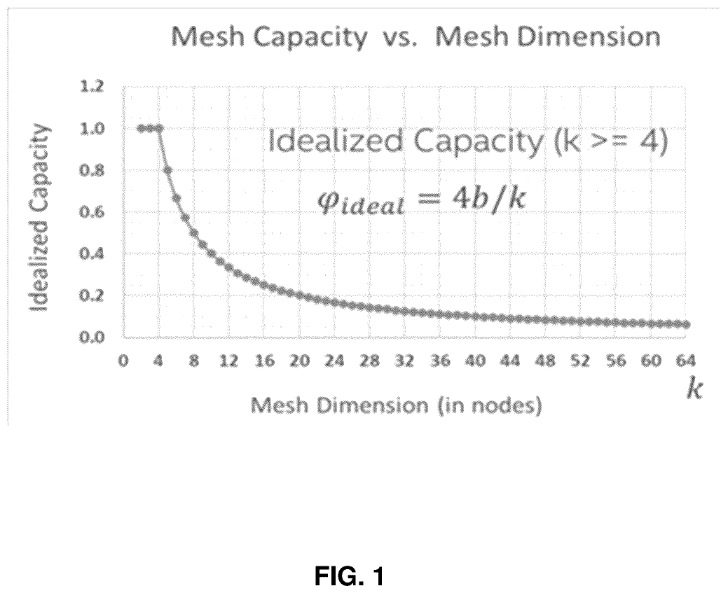

FIG. 1 depicts an example relationship between capacity and mesh dimensions. The x-axis lists a number of nodes ‘k’ along a single edge of a 2D array, where each node is coupled to a network endpoint. The y-axis lists a capacity level with a peak capacity level normalized to 1.0. For a standard test configuration, the value for the capacity exhibits a 1/k roll off with increasing k from a peak capacity level of 1.0.

Moreover, as bandwidth decreases asymptotically, the transport energy may increase linearly with k. A packet's energy consumption can include an aggregate of the energy consumed by the packet at routers along its signal path and on the intervening channels. When a uniform mesh is scaled up, at least a subset of the packets traverse longer distances, passing through more routers, and may incur a linear increase in energy consumption. The 4b/k inverse roll off is derived analytically and assumes a uniform traffic pattern and a fixed channel bandwidth. The variable b can represent channel bandwidth. The plot depicts peak sustained bandwidth as seen by each terminal element in the network normalized to the bandwidth of a single channel.

However, because of a combination of device shrinkage and expanding socket size, increasing diameter mesh geometries are utilized. For some system on chip (SoC) architectures, scale up is bounded by the power, throughput, and latency of the mesh networks. As a number of terminal elements scales, achieving combined targets for bandwidth, latency, and energy usage can be a challenge.

Various examples provide a router architecture and utilize a routing configuration to assemble groups of links into meshes that operate at multiple length scales or hop count. A router architecture can include a pattern of a 3D hierarchy of meshes with one or more express links assembled into multiple meshes of different length scales. A mesh can be overlaid onto a fine-grain base mesh that connects tiles. A node can include a single composite router that can route packet traffic to endpoints for multiple mesh levels. At nodes where the endpoints of multiple mesh levels overlap, a composite router can bridge packet traffic between the mesh levels. Traces can be embedded in a reticle (e.g., super-reticle (s.r.)), such as a Complementary Metal-Oxide-Semiconductor (CMOS) metal stack. In some examples, an area of the metal stack can be as large as a footprint of a 2×2 array of reticles. Express links can be embedded in the metal stacks of the reticle and endpoints (potentially including routers) can be arrayed in the chiplets. Hybrid Bonding Interconnect (HBI) bonding (e.g., direct thermal compression bonding of copper pads to provide communication between Complementary Metal-Oxide-Semiconductor (CMOS) structures organized in a 3D stack) can be used to route signals from the routers in the chiplets to the express link traces in the reticle. Signal pathways between ports on non-adjacent network endpoints can pass through express links in the reticle (e.g., super-reticle).

When a stepper moves to a fixed location on a wafer, the stepper shines light through a mask (e.g., reticle) to project a pattern onto a silicon wafer. The area of silicon that can be exposed is limited by the size of the mask. A reticle can include one or more die and traces can be as long or longer than a dimension of a die. A super-reticle can include a monolithic CMOS structure that is too large to be created by a sequence of lithographic exposures at a fixed location on a wafer. A super-reticle can include a CMOS structure that includes a stack of CMOS metal layers. Patterning monolithic structures larger than a reticle can utilize reticle stitching where the boundary regions between two reticles sites are multiple exposed by reticle projections from each of multiple reticle sites. Metal traces can be patterned that bridge across the boundary region between multiple reticles.

A node can provide an endpoint for at least one mesh. A node can include a router that services network endpoints located at the node. A junction router provides endpoints for multiple meshes. A junction router can be provisioned to enable packet transits between the meshes. A mesh topology can include one or more of: a ring, mesh, or torus, arranged in a 2D cartesian or hexagonal grid configurations.

A signal path can depart a port on a source endpoint, follow a via downward to one end of the express link trace, traverse the trace, and proceed upward to a port on the destination endpoint. Some endpoints can include a baseline number of ports to signal to its terminal element and to the nearest neighbor endpoints. The remaining endpoints can have additional ports to signal over the express links.

Various examples can define a routing configuration that causes a portion of a packet's signal path to be routed through the express links. A routing configuration can cause the packets to travel on express meshes where packets can travel farther, faster, and at reduced energy usage. Express meshes can be embedded into a passive monolithic silicon carrier, operate at a reduced clock frequency, and employ low-swing signaling to enable signal integrity that can support, e.g., over 20+ mm of channel length at sub picojoule (pJ)/bit of energy.

Various examples provide for scaling up mesh topologies. In some examples, a single hierarchical mesh topology can scale to an area of a 8 inch×8 inch wafer cut-out, or other sizes. In some examples, express links can signal up to 30 mm with <1.0 pJ/bit of energy. In some examples, express links can include traces of length 4 mm to 30 mm.

Various examples disaggregate the router design into trace-length-specific routing elements and organize individual express link traces into express meshes. Various examples create a 3D hierarchy of 2D express meshes, with different levels of the hierarchy defined by characteristic length scale for the channels (e.g., up to 20 mm or other lengths). Various examples can embed the traces for the express meshes in a transmission medium for signaling at the target length scale, and/or lower the clock frequency for achieving signal integrity at the target length scale. Various examples can arrange junction routers in a diagonal pattern to allow non-interfering place-and-route to the express mesh channels underneath.

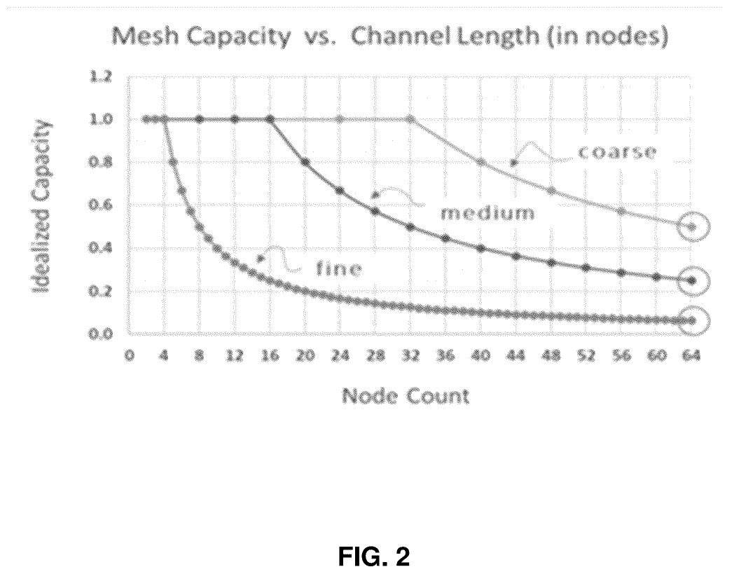

FIG. 2 depicts an example capacity of the multiple meshes as a function of endpoint pitch. Based on an assumption of a uniform traffic pattern, plots show an analytic peak of the endpoint injection bandwidth, normalized to the fixed channel bandwidth, for different meshes. For a coarse express mesh, medium express mesh, and fine mesh, the three curves depict the roll-off in the analytic peak throughput as a function of the channel length (measured in nodes). The x-axis is the dimension of the 2D mesh, where k=64 and corresponds to a 64×64 mesh. The y-axis is an analytic value for the peak sustained injection bandwidth at an endpoint and is normalized to the fixed bandwidth of the channel. The sample points (circles) represent nodes with network endpoints. A number of network endpoints that a packet transits through along its signal path can be a proxy for energy consumed by a packet as it transits the elongated signal paths.

In some examples, a coarse express mesh connects with a network endpoint every eighth node and the channel length is eight nodes such that every eighth node is directly addressable, although other numbers of nodes can be used. For a 64×64 node mesh, the analytic peak injection bandwidth is 8x that of the fine grain mesh. The proxy value for energy per packet is ⅛^{th} that of the energy per packet on the fine grain mesh.

A medium express mesh can connect with a network endpoint every fourth node and the channel length is four nodes so that every fourth node is directly addressable, although other numbers of nodes can be used. For a 64×64 node mesh, the analytic peak injection bandwidth is 4× that of the fine grain mesh. The proxy value for energy per packet is ¼^{th} that of the energy per packet on the fine grain mesh.

A fine base mesh can connect with a network endpoint at every node and channels connect proximal nodes so that every node is directly addressable. However, the throughput attenuation as a function of the node array dimension is greatest for a fine base mesh compared to that of the medium or coarse mesh. The packet transport energy is likewise greatest compared to that of the medium or coarse mesh because a packet transits through an endpoint at every node along its path.

In some examples, a minimum length for the longest links can be on the order of ⅛^{th} of the dimension of the node array. For example, if the base mesh was a 16×16 array spread over a silicon area of 24 mm×28 mm, then a first cut minimum distance for the longest express link could be 3.5 mm (e.g., 28 mm/8). By this metric, for smaller sockets where the spatial domain of the network is on the order of 50 mm×50 mm, the longest express links could be O(7 mm). At this length, the express link could be embedded in a same Complementary Metal-Oxide-Semiconductor (CMOS) chiplet as that of a base mesh. In this model, the express links can be regarded as engineered derivatives of the links in the fine grain base mesh. Here, the latency-energy-bandwidth performance of the express mesh channels are within small scalar factors of the performance of the smaller base mesh channels.

In a large socket case, where the network dimensions expands to O(120 mm), the largest express links can become tens of millimeters long. In this example, the express links could be moved off of the compute chiplets and embedded in a separate signaling medium, where link lengths could exceed the rectangular dimension of the chiplets. The latency-energy-bandwidth operating point of the largest express links differ from the operating point of the links in the base mesh. This divergence in operating points yields performance penalties that can largely obviate key gains seen in the small area model.

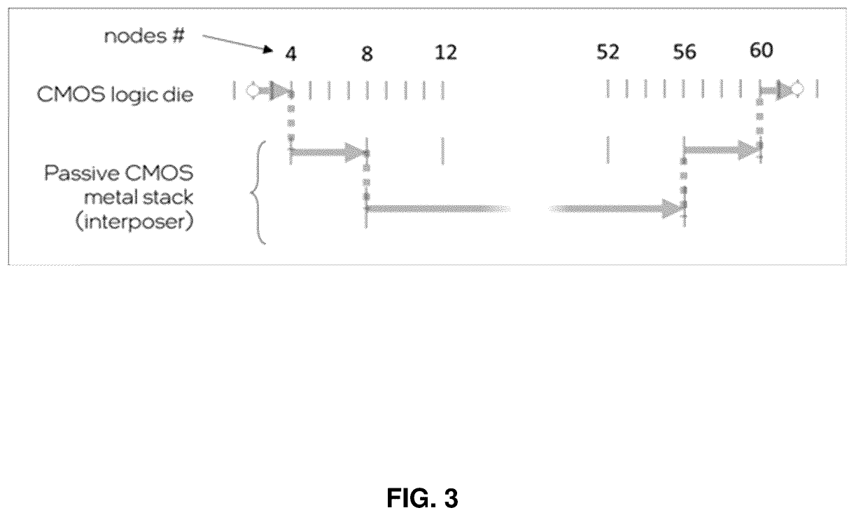

FIG. 3 depicts an example of the routing path on a composite mesh. In some examples, three separate meshes can be combined into a single 3-level composite mesh where three separate meshes are overlaid on an array of nodes. A mesh can be defined by its number of endpoints and the spacing between endpoints (measured in nodes). A node can include a single composite router that can service endpoints for multiple mesh levels. At nodes where the endpoints of multiple mesh levels overlap, the composite router can bridge packet traffic between the mesh levels. An energy consumption-based routing scheme can route packets on the long-channel express meshes between nodes. In some examples, a node span can indicate a distance measured in nodes or physical distance. As shown in FIG. 3, node spans can be 1, 4, or 8, although other numbers of node spans can be used.

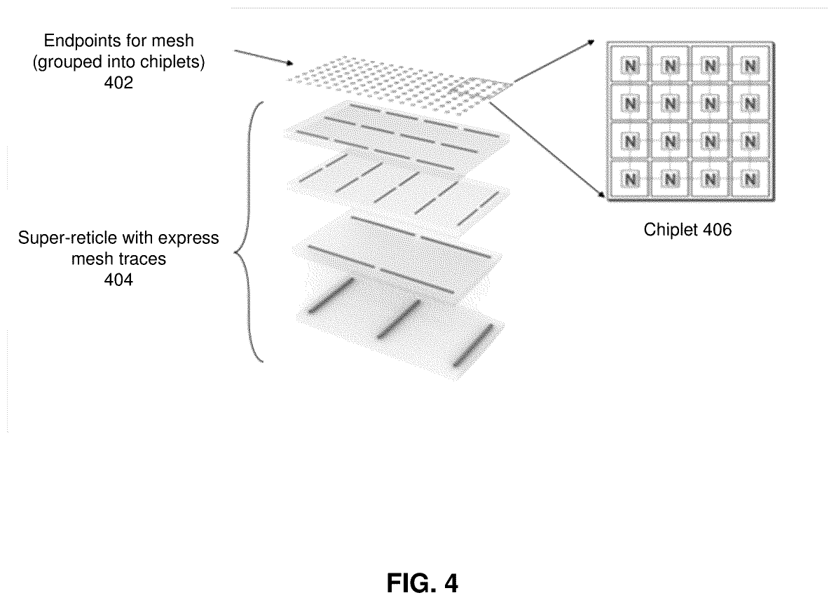

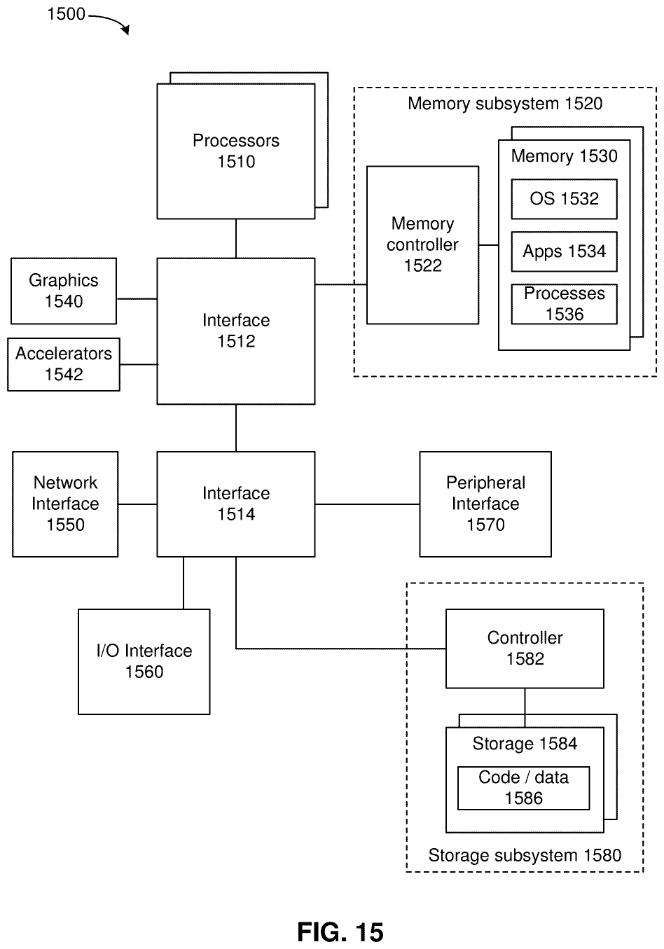

FIG. 4 depicts an example chiplet arrangement. Chiplet 406 can include one or more nodes or tiles. A node can include at least one tile or die. Tiles can be arranged in an array and tiles can be connected by metal traces. A tile can include transistors (e.g., compute, adders, multipliers, latches, memory, or other circuitry) where transistors are connected by metal traces. Integrated circuits can include an arrays of tiles and a tile can be connected to another tile by metal traces. In some examples, a chiplet can include a 4×4 array of tiles. A tile may include a computing element, a processor core, a core, a processing engine, an execution unit, a central processing unit (CPU), caches, switches, a network endpoint, a router, and other circuitry described herein at least with respect to FIG. 15. A network endpoint can include transmitter (Tx) and receiver (Rx) drive circuits for signaling within a tile and/or among tiles. A tile can include a composite router (N) to connect with a nearest neighbor interconnect or to communicate using mesh channels that terminate in the tile. Junction routers can bridge packet traffic between the on-die (e.g., fine-grain) mesh and one or more express-meshes. Traces for the express meshes can be grouped based on direction (x, y) and length scale (e.g., medium pitch, coarse pitch). A trace group can be embedded in a layer of the reticle.

Chiplets can be bonded to a surface of a reticle by Hybrid Bonding Interconnect (HBI), or other technologies. Mesh traces in the reticle can be conductively coupled to junction routers of particular chiplets. For example, a 16×16 array of chiplets can be bonded to a top face of a reticle, resulting is a 64×64 array of network endpoints. A chiplet can be organized as a 4×4 array of tiles and a tile can include router circuitry for a network endpoint.

As the pitch of the hybrid metal bonding (HBI) reduces in size, the reticle operates as a set of additional layers that have been added to the metal stack of the CMOS chiplets. The properties of the additional layers are the multi-reticle 2D form factor, control of the trace pitch, and low energy signaling across the 3D boundary.

As described herein, a reticle can include medium and coarse pitched express meshes. A reticle can include embedded traces for express links. A reticle layer can include a trace of a particular length and direction. The material and electrical properties of the reticle layer can allow trace geometries that promote low latency and energy efficient signaling. Lowering the clock frequency can enable use of longer trace lengths, even compared to the rectangular dimensions of the chiplets.

The fine-grain mesh is the on-die interconnect between the routers. Bridge traces at the die boundaries stitch the individual chiplet meshes into a single fine-grain fabric.

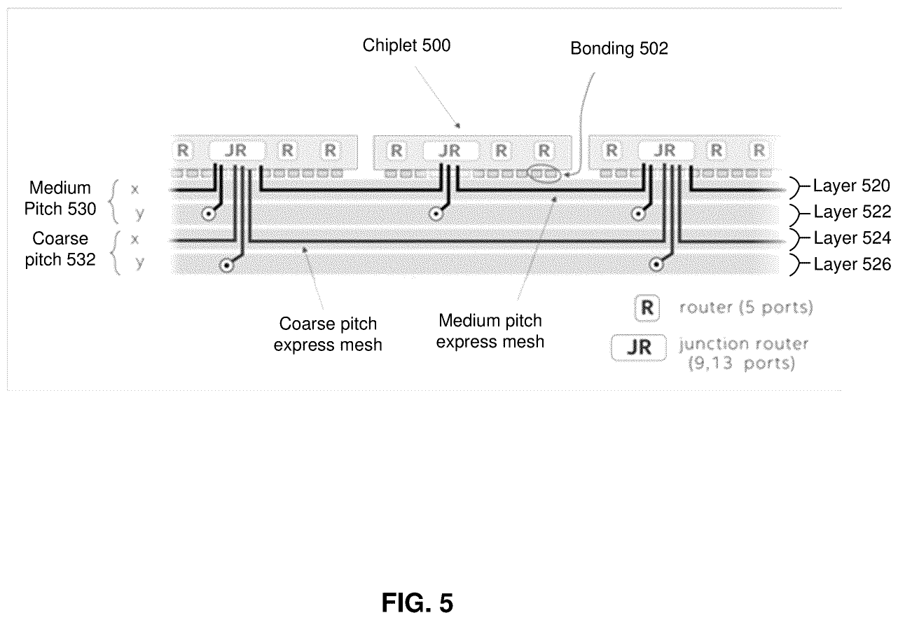

FIG. 5 depicts an example of express mesh signal paths. A reticle can include a stack of CMOS metal layers. In some examples, a reticle can include a 4-layer stack of CMOS metal layers 520, 522, 524, and 526. For example, medium pitch express mesh 530 can be embedded in layers 520 and 522 whereas coarse pitch express mesh 532 can be embedded in layers 524 and 526.

The reticle can be scalable to an 8 in×8 in form factor or other sizes. The 2D on-die mesh and two express meshes can be organized in 3-level hierarchy. In some examples, multiple express link traces can be embedded in four layers of the reticle. An example channel length for a short haul mesh can be 10 mm and an example length of a long haul mesh can be 20 m. However other numbers of layers and channel lengths of the mesh can be used.

Note that examples are not limited to the use of a reticle, and express meshes can utilize signaling media such as silicon interposers, package substrate, and board-scale printed circuitry board (PCB) and the associated 3D integration technologies, e.g., microbumps, bumps, and ball grid arrays (BGAs).

Receiver routers or chiplets can experience congestion when receiving packets from one or more senders at a higher rate than a throughput of a receiver chiplet 500. In cases of congestion, a receiver chiplet 500 can cause flow control by the one or more sender chiplets or circuitries to slow or pause a rate of data or packet transmissions to chiplet 500 or pause. The one or more sender chiplets or circuitries can utilize egress buffers to hold packets, halt or slow computing stop to reduce a rate of packet transmissions, or drop packets.

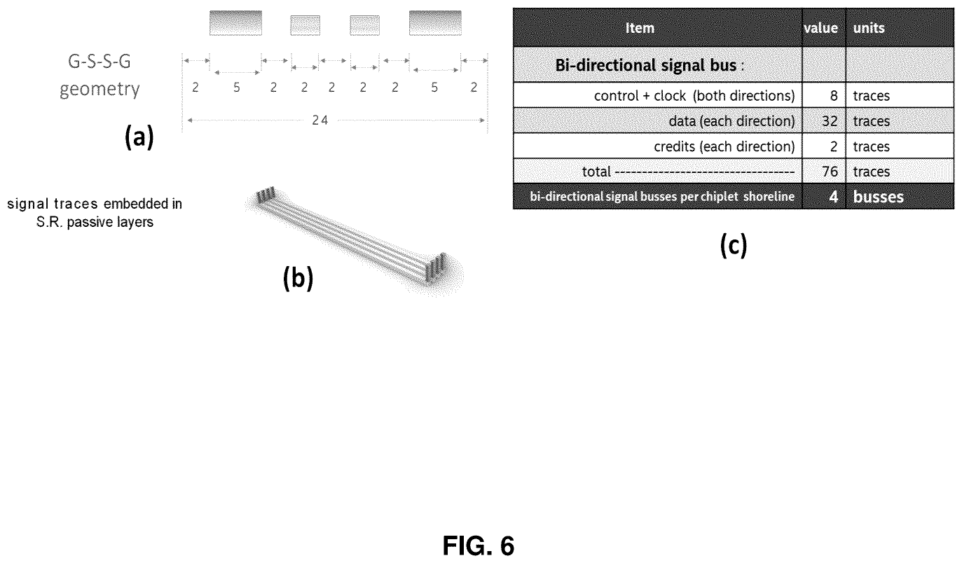

FIG. 6 depicts an example of a cross sectional view of a structure. The structure can include an elemental ground-signal trace-signal trace-ground (G-s-s-G) grouping (2 signal traces bookended by a pair of grounds). Signal paths in a reticle can include pairs of coplanar wave guides grouped in the G-s-s-G bundles. A bundle can include mm-scale traces embedded in the reticle (e.g., super reticle (s.r.)) with vias extending upward to the chiplets. For example, in a set of 4-way trace-groups, lithographic vias can connect the traces below to the endpoint in the chiplets above.

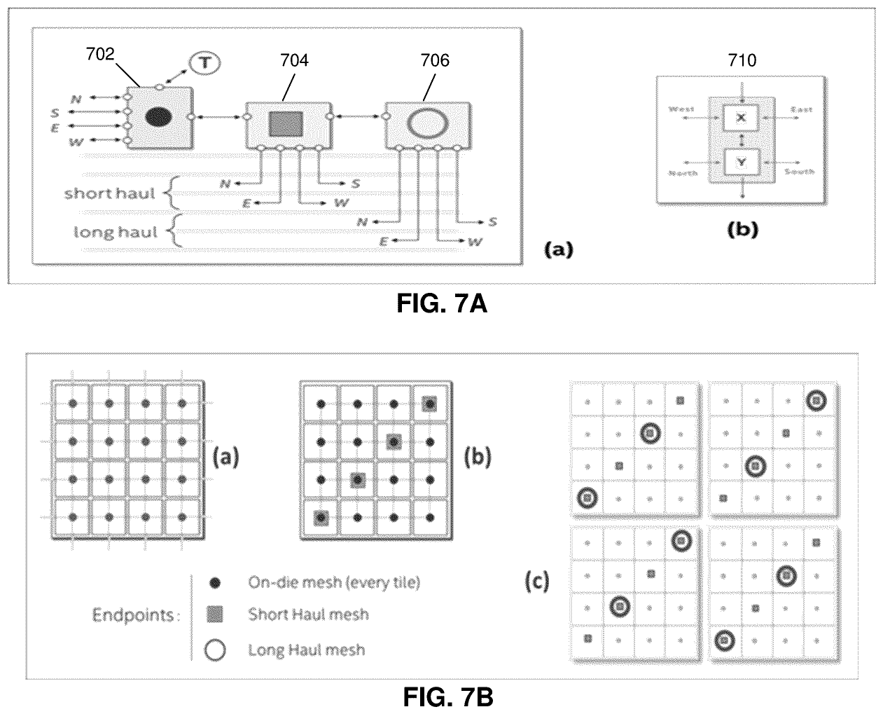

FIG. 7A depicts an example of a composite router. As shown in (a), a composite router can include multiple composite routers 702, 704, and 706 to route traffic respectively among (1) an on-die mesh that transfers traffic among tiles, (2) a short haul (medium) express mesh, and/or (3) a long haul (coarse) express mesh. Router 702 can provide north, south, east, or west direction bi-directional communication among an on-die mesh that transfers traffic among tiles. Router 704 can provide 2D bi-directional communications (e.g., north, south, east, or west direction) with a short haul mesh and be communicatively coupled to routers 702 and 706 to receive or forward communications. Router 704 can provide 2D bi-directional communications (e.g., north, south, east, or west direction) with a short haul mesh and be communicatively coupled to routers 702 and 706 to receive or forward communications. Router 706 can provide 2D bi-directional communications (e.g., north, south, east, or west direction) with a long haul mesh and be communicatively coupled to routers 702 and 704 to receive or forward communications. A number of layers are exemplary and more or fewer lengths can be used. A number of unique length scales (e.g., short and long hauls) are exemplary and more or fewer length scales can be used.

As shown in (b), composite router 710 can be implemented as a pair of low-radix input-queued routers. The x can represent a left and right directions. The y can represent in and out of the page.

The clock frequency can be set at different levels for different mesh levels. A clock frequency of a signal transmitted using the short haul can be twice of the clock frequency of the signal transmitted using the long haul.

FIG. 7B depicts an example of terminal locations. Positioning the channel access points balances: (1) uniform channel density at the tile boundaries with no holes or voids in the reticle layers, (2) endpoints of the express buses spatially aligned so that a single junction router can manage traffic between multiple mesh layers, and (3) uniform spatial distribution to reduce a worst-case distance between a random point on the grid and the nearest grid point that hosts an express mesh.

For example, item (a) depicts terminal locations for an on-die mesh. A tile includes terminal points for the channels from the tile's nearest neighbor tiles, including neighbors on the other side of the die-to-die bridge. For example, item (b) depicts a subset of the endpoints that bridge between the on-die mesh and the short haul mesh. For example, item (c) depicts a subset of the endpoints that bridge between all three mesh levels and a mapping on a 2×2 array of chiplets. The pattern of terminal locations in this 2×2 chiplet group repeats as the chiplet count grows.

The endpoints of the express mesh need not be spatially aligned. Instead, individual length scales (short or long express links) can interface to the on-die network at a junction routers for such length scale. In addition, positions of the junction routers can vary from chiplet-to-chiplet.

A chiplet can be organized as a 4×4 array of tiles or nodes. A tile can include one or more of: a router 702, router 704, or router 706. For a tile where multiple mesh layers overlap, the router can include a junction router that can bridge traffic between the mesh layers.

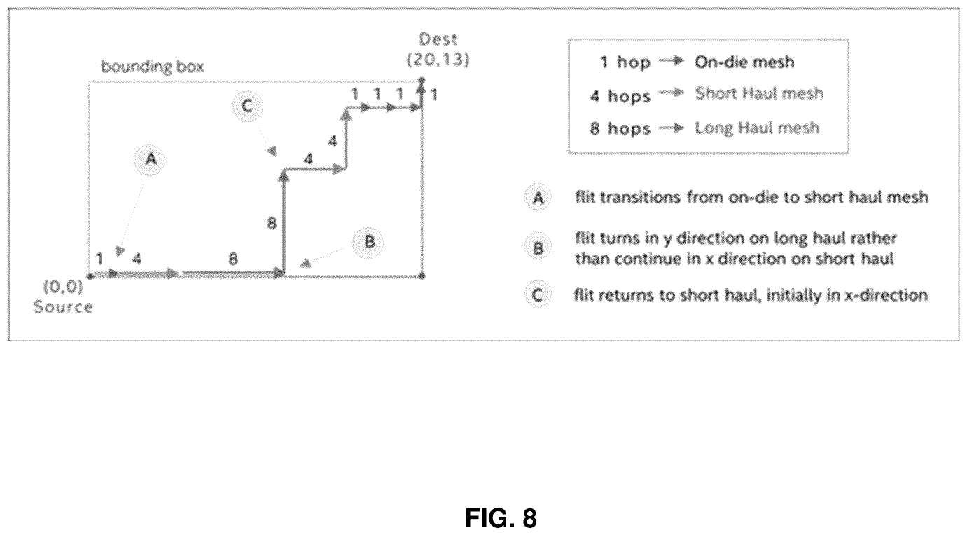

FIG. 8 depicts an example sample routing path. For communications between tiles within a chiplet, an on-die mesh can be used. For communications between nodes that are spaced 4 node hops away from each other, a short haul mesh can be used. For communications between nodes that are spaced 8 node hops away from each other, a long haul mesh can be used. Communications can be routed through a combination of on-die mesh and one or more of the express links.

The routing function can be a dimension ordered dimensionally constrained (DODC) routing function modified for use on sparse hamming graphs. Source and destination grid points define the bounding box. At endpoints that service multiple mesh levels, a Dimension Ordered/Dimensionally Constrained (DODC) routing function that balances latency and energy can select a longest path that still remains in the bounding box (e.g., points A and C). Within a given mesh level, DODC uses a dimension-ordered routing (DOR) routing operation (e.g., point B). The source and destination grid points define a bounding box. The DOR algorithm walks the periphery of that bounding box, one grid point per clock cycle. By contrast, at grid points where the local router serves multiple mesh levels, DODC selects a mesh level with a longest path that remains in the bounding box. Regardless of the channel's length, a DODC transit utilizes one clock cycle. In the example, where the source is at node location (0,0) on a grid and a node location at the destination is at (20,13), the best case DOR latency is 33 hops, and the best case DODC latency is 10.

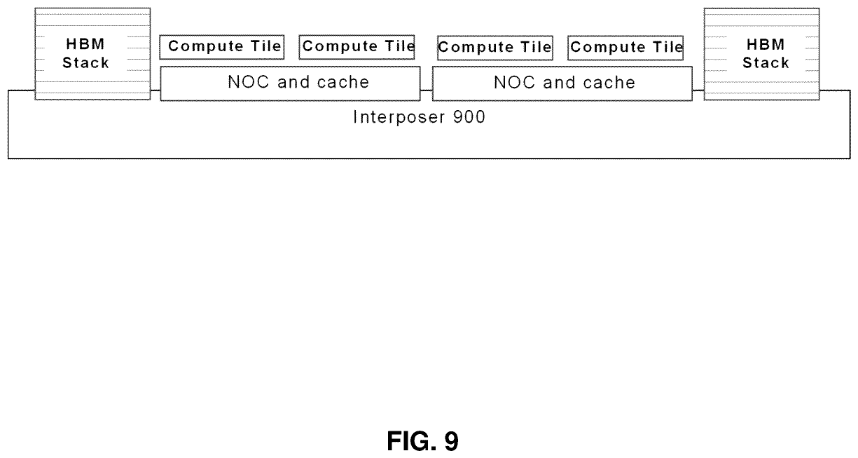

FIG. 9 depicts an example architecture. Network on chip (NOC), compute and cache components can be clustered separately from High Bandwidth Memory (HBM) in separate 2D groupings with compute components clustered in a center of the package and the HBM stacks forming a ring on the periphery. Interposer 900 can include multiple layers with a 3D hierarchy of 2D meshes connecting different node spans, described herein. Data from HBM can enter the mesh of interposer 900 at interface points. Mesh endpoints can provide communication among cores and top level cache (e.g., L1, L2, or distributed L3).

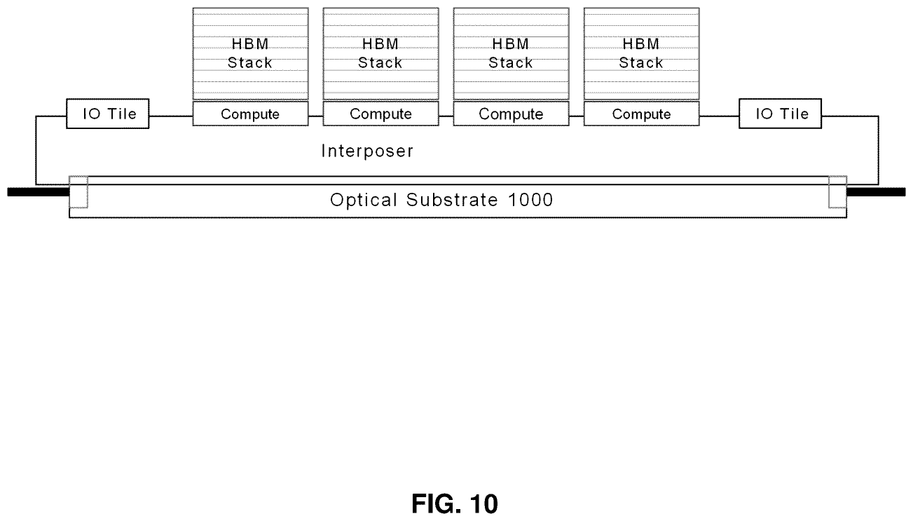

FIG. 10 depicts an architecture for acceleration of artificial intelligence (AI)-related operations. Compute circuitry and HBM can be vertically aligned in 3D stacks. Substrate 1000 can include multiple layers with a 3D hierarchy of 2D meshes connecting different 3D stacks of compute and HBM, described herein.

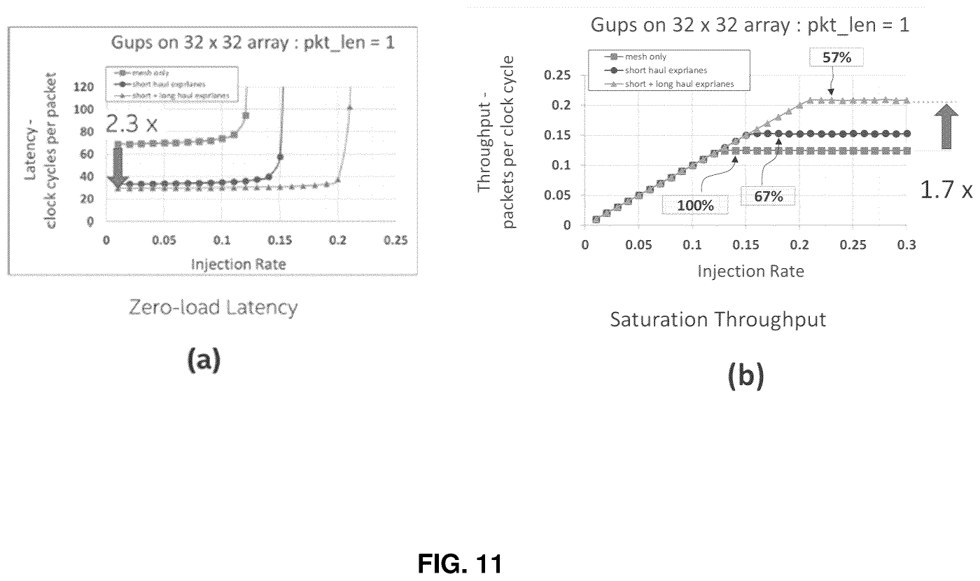

FIG. 11 depicts an example of latency and throughput on a 32×32 array as a baseline for simple examination of network scale up. For a uniform traffic pattern and a 32×32 node array, and for three network configurations, (1) on-die mesh only, (2) on-die mesh and short haul, and (3) on-die mesh, short haul, and long haul meshes: plot (a) depicts latency versus injection rate whereas plot (b) throughput versus injection rate. The percentage labels in (b) show the aggregate channel utilization for different network configurations. Between configurations (1) and (3), the zero-load latency improves by 2.3× and the saturation throughput improves by 1.7×.

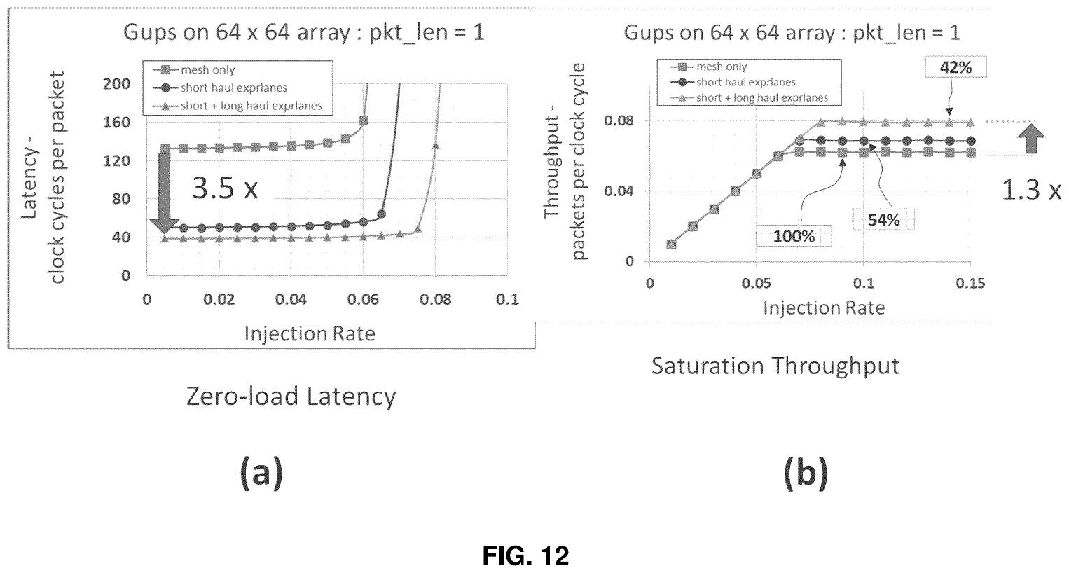

FIG. 12 depicts an example of latency and throughput on a 64×64 array for configurations (1)-(3). Relative to the 32×32 baseline of FIG. 11, the improvement in the zero load latency increases from 2.3× to 3.5× and the gain of the saturation throughput decreases from 1.7× to 1.3×. The channel utilization for the two network configurations that use the express meshes likewise decreases.

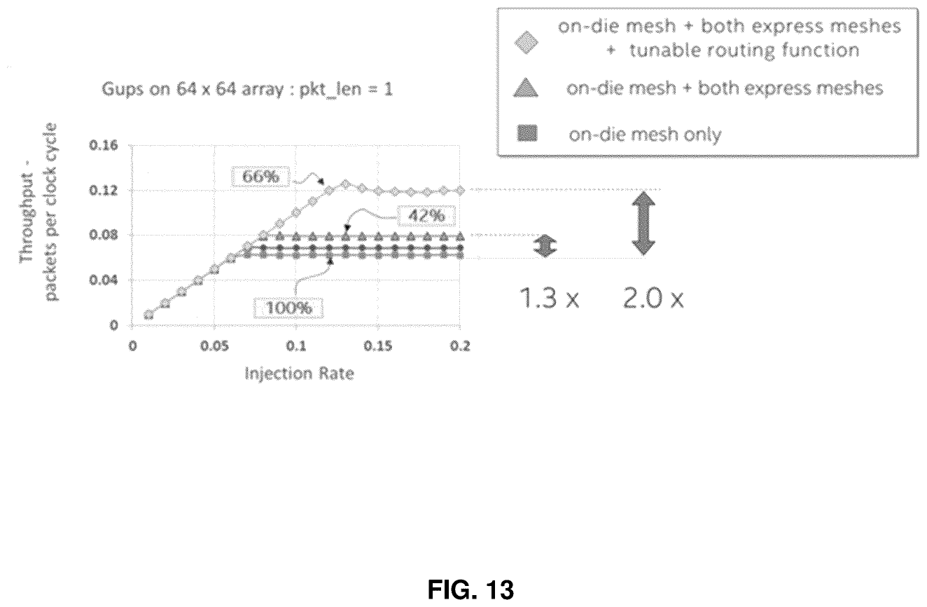

FIG. 13 depicts an example of throughput versus injection rate for a tunable routing function. Application of this routing function restores the express-mesh throughput gain from 1.3× to 2.0× by increasing the average channel utilization from 42% to 66%.

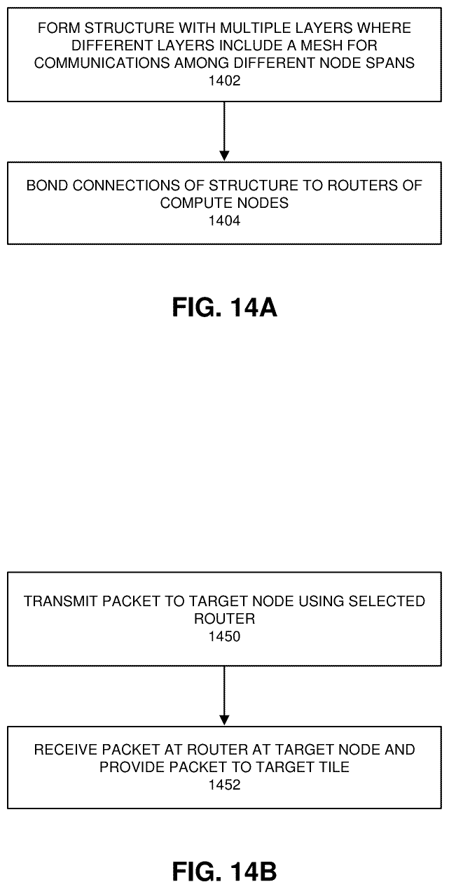

FIG. 14A shows an example process to form a structure. At 1402, a structure can be formed that includes a three dimensional (3D) hierarchy of two dimensional (2D) meshes. For example, traces of a mesh can be embedded in layers of a Complementary Metal-Oxide-Semiconductor (CMOS) metal stack. Traces can be formed of electrical or optically conductive materials such as aluminum, gold, copper, silica glass, polymethyl methacrylate (PMMA), or others. The traces can be set to implement a routing function between different node chiplets. For example, a trace in a particular layer can skip A number of nodes to provide a node-to-node space of A nodes. For example, a second trace in a second particular layer can skip B number of nodes to provide a node-to-node space of B nodes, where B>A.

At 1404, connections of the traces can be coupled to nodes. For example, nodes can be bonded to connections of traces by Hybrid Bonding Interconnect (HBI), or other technologies.

FIG. 14B depicts an example process to communicate among different chiplets. At 1450, a source node can select a router or connection to transmit a packet to a target tile in a target node based on a routing algorithm, which reads a packet header to decide an output port to egress a packet from. For example, if a target node is a tile on the same node as that of the source node, a packet to be transmitted via a first router uses the on-die mesh in the node. As another example, if the target node is a tile on a different node as that of the source node and a node gap of A, a packet to be transmitted uses a second router to the target node. For example, if a target node is tile on a different node as that of the source node and the node gap is B, a packet to be transmitted uses a third router to the target node.

At 1450, the target node can receive the transmitted packet from a router. For example, the router that received the transmitted packet can be based on a node span between the source and target nodes. A junction router can bridge packet traffic between an express mesh and the on-die mesh to direct the packet to the target tile in the target node.

FIG. 15 depicts a system. In some examples, processor 1510, graphics 1540, one or more of accelerators 1542, and/or network interface 1550 can utilize communication and routing techniques, described herein. System 1500 includes processor 1510, which provides processing, operation management, and execution of instructions for system 1500. Processor 1510 can include any type of microprocessor, central processing unit (CPU), graphics processing unit (GPU), processing core, or other processing hardware to provide processing for system 1500, or a combination of processors. Processor 1510 controls the overall operation of system 1500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1500 includes interface 1512 coupled to processor 1510, which can represent a higher speed interface or a high throughput interface for system components that need higher bandwidth connections, such as memory subsystem 1520 or graphics interface components 1540, or accelerators 1542. Interface 1512 represents an interface circuit, which can be a standalone component or integrated onto a processor die.

Accelerators 1542 can be a fixed function or programmable offload engine that can be accessed or used by a processor 1510. For example, an accelerator among accelerators 1542 can provide data compression (DC) capability, cryptography services such as public key encryption (PKE), cipher, hash/authentication capabilities, decryption, or other capabilities or services. In some cases, accelerators 1542 can be integrated into a CPU socket (e.g., a connector to a motherboard or circuit board that includes a CPU and provides an electrical interface with the CPU). For example, accelerators 1542 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 1542 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 1520 represents the main memory of system 1500 and provides storage for code to be executed by processor 1510, or data values to be used in executing a routine. Memory subsystem 1520 can include one or more memory devices 1530 such as read-only memory (ROM), flash memory, one or more varieties of random access memory (RAM) such as static random-access memory (SRAM), dynamic random-access memory (DRAM), or other memory devices, or a combination of such devices. Memory 1530 stores and hosts, among other things, operating system (OS) 1532 to provide a software platform for execution of instructions in system 1500. Additionally, applications 1534 can execute on the software platform of OS 1532 from memory 1530. Applications 1534 represent programs that have their own operational logic to perform execution of one or more functions. Processes 1536 represent agents or routines that provide auxiliary functions to OS 1532 or one or more applications 1534 or a combination. OS 1532, applications 1534, and processes 1536 provide software logic to provide functions for system 1500. In one example, memory subsystem 1520 includes memory controller 1522, which is a memory controller to generate and issue commands to memory 1530. It will be understood that memory controller 1522 could be a physical part of processor 1510 or a physical part of interface 1512. For example, memory controller 1522 can be an integrated memory controller, integrated onto a circuit with processor 1510.

In some examples, OS 1532 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

While not specifically illustrated, it will be understood that system 1500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1500 includes interface 1514, which can be coupled to interface 1512. In one example, interface 1514 represents an interface circuit, which can include standalone components and integrated circuitry. In one example, multiple user interface components or peripheral components, or both, couple to interface 1514. Network interface 1550 provides system 1500 the ability to communicate with remote devices (e.g., servers or other computing devices) over one or more networks. In some examples, network interface 1550 can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Network interface 1550 can include an Ethernet adapter, wireless interconnection components, cellular network interconnection components, USB (universal serial bus), or other wired or wireless standards-based or proprietary interfaces. Network interface 1550 can transmit data to a device that is in the same data center or rack or a remote device, which can include sending data stored in memory.

Some examples of network interface 1550 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Some examples of network interface 1550 can include a programmable packet processing pipeline with one or multiple consecutive stages of match-action circuitry. The programmable packet processing pipeline can be programmed using one or more of: Protocol-independent Packet Processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), x86 compatible executable binaries or other executable binaries, or others.

In one example, system 1500 includes one or more input/output (I/O) interface(s) 1560. I/O interface 1560 can include one or more interface components through which a user interacts with system 1500 (e.g., audio, alphanumeric, tactile/touch, or other interfacing). Peripheral interface 1570 can include any hardware interface not specifically mentioned above. Peripherals refer generally to devices that connect dependently to system 1500. A dependent connection is one where system 1500 provides the software platform or hardware platform or both on which operation executes, and with which a user interacts.

In one example, system 1500 includes storage subsystem 1580 to store data in a nonvolatile manner. In one example, in certain system implementations, at least certain components of storage 1580 can overlap with components of memory subsystem 1520. Storage subsystem 1580 includes storage device(s) 1584, which can be or include any conventional medium for storing large amounts of data in a nonvolatile manner, such as one or more magnetic, solid state, or optical based disks, or a combination. Storage 1584 holds code or instructions and data 1586 in a persistent state (e.g., the value is retained despite interruption of power to system 1500). Storage 1584 can be generically considered to be a “memory,” although memory 1530 is typically the executing or operating memory to provide instructions to processor 1510. Whereas storage 1584 is nonvolatile, memory 1530 can include volatile memory (e.g., the value or state of the data is indeterminate if power is interrupted to system 1500). In one example, storage subsystem 1580 includes controller 1582 to interface with storage 1584. In one example controller 1582 is a physical part of interface 1514 or processor 1510 or can include circuits or logic in both processor 1510 and interface 1514.

A volatile memory is memory whose state (and therefore the data stored in it) is indeterminate if power is interrupted to the device. A non-volatile memory (NVM) device is a memory whose state is determinate even if power is interrupted to the device.

In an example, system 1500 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network, interconnect, or circuitry that provides chipset-to-chipset communications, die-to-die communications, packet-based communications, communications over a device interface (e.g., PCIe, CXL, UPI, or others), fabric-based communications, and so forth. A die-to-die communications can be consistent with Embedded Multi-Die Interconnect Bridge (EMIB).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal (e.g., active-low or active-high). The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples and includes an apparatus that includes a device that includes: a plurality of nodes, wherein a node of the plurality of nodes comprises at least one processor and a structure comprising multiple physical layers, wherein different physical layers of the multiple physical layers are to provide communication entry points to at least some of the same nodes at different node spans by a stack of overlapping two dimensional (2D) meshes.

Example 2 includes one or more prior or later examples, wherein: a first layer of the multiple layers comprises a first trace that comprises a link that connects a first span of nodes and a second layer of the multiple layers comprises a second trace that comprises a link that connects a second span of nodes, where the first span of nodes is greater than the second span of nodes.

Example 3 includes one or more prior or later examples, wherein the node of the plurality of nodes comprises a processor and/or memory.

Example 4 includes one or more prior or later examples, and includes an on-die mesh for communications among the plurality of nodes.

Example 5 includes one or more prior or later examples, wherein the node of the plurality of nodes comprises a router and wherein the router is communicatively coupled to at least one of the 2D meshes.

Example 6 includes one or more prior or later examples, wherein: a configuration is to specify routing of communications among the nodes via the 2D meshes.

Example 7 includes one or more prior or later examples, wherein at least one processor comprises: a graphics processing unit (GPU), central processing unit (CPU), or accelerator.

Example 8 includes one or more prior or later examples, and includes a method that includes: routing of packets among nodes via different physical layers connecting different node spans and based on congestion at a receiver device, reducing transmission of packets to the receiver device.

Example 9 includes one or more prior or later examples, and includes selecting an outgoing port on a router to route the packets based on a target node.

Example 10 includes one or more prior or later examples, and includes selecting an output port to an on-die mesh to route the packets based on the target node being in a same chiplet as a chiplet of a sender node.

Example 11 includes one or more prior or later examples, and includes selecting a first router to route the packets based on the target node being a first node span from a sender node.

Example 12 includes one or more prior or later examples, and includes selecting a port to a second router to route the packets based on the target node being a second node span from a sender node, wherein the second node span is greater than the first node span.

Example 13 includes one or more prior or later examples, and includes processing the packets at the target node after receiving the packets.

Example 14 includes one or more prior or later examples, and includes transmitting the packets using a signal and wherein a frequency of the signal is based on a number of hops that the packets traverse.

Example 15 includes one or more prior or later examples, and includes an apparatus that includes: a device that includes: a first trace that comprises a link that connects nodes separated by A number of nodes of a plurality of nodes and a second trace that comprises a link that connects nodes separated by B number of nodes of the plurality of nodes, where B is greater than A, wherein: a node of the plurality of nodes comprises a processor, memory, and a router, and the router is communicatively coupled to the first trace and the second trace.

Example 16 includes one or more prior or later examples, wherein the node of the plurality of the nodes comprises multiple communicative couplings among circuitry of the node.

Example 17 includes one or more prior or later examples, wherein: the router is communicatively coupled to the first trace, the second trace, and at least one of the multiple communicative couplings.

Example 18 includes one or more prior or later examples, wherein: the device comprises multiple layers, a first set of the multiple layers includes the first trace, and a second set of the multiple layers includes the second trace.

Example 19 includes one or more prior or later examples, wherein: a configuration is to specify routing of communications between multiple nodes of the plurality of nodes from among the first trace, the second trace, or a communicative coupling of the multiple communicative couplings.

Example 20 includes one or more prior or later examples, wherein the router is to receive a signal and wherein a frequency of the signal is based on a number of hops that the signal traverses.

1. An apparatus comprising:
a device comprising:
a plurality of nodes, wherein a node of the plurality of nodes comprises at least one processor and
a structure comprising multiple physical layers, wherein different physical layers of the multiple physical layers are to provide communication entry points to at least some of the same nodes at different node spans by a stack of overlapping two dimensional (2D) meshes.

2. The apparatus of claim 1, wherein:
a first layer of the multiple layers comprises a first trace that comprises a link that connects a first span of nodes and
a second layer of the multiple layers comprises a second trace that comprises a link that connects a second span of nodes, where the first span of nodes is greater than the second span of nodes.

3. The apparatus of claim 1, wherein the node of the plurality of nodes comprises a processor and/or memory.

4. The apparatus of claim 1, comprising an on-die mesh for communications among the plurality of nodes.

5. The apparatus of claim 1, wherein the node of the plurality of nodes comprises a router and wherein the router is communicatively coupled to at least one of the 2D meshes.

6. The apparatus of claim 1, wherein:
a configuration is to specify routing of communications among the nodes via the 2D meshes.

7. The apparatus of claim 1, wherein at least one processor comprises: a graphics processing unit (GPU), central processing unit (CPU), or accelerator.

8. A method comprising:
routing of packets among nodes via different physical layers connecting different node spans and
based on congestion at a receiver device, reducing transmission of packets to the receiver device.

9. The method of claim 8, comprising:
selecting an outgoing port on a router to route the packets based on a target node.

10. The method of claim 9, comprising:
selecting an output port to an on-die mesh to route the packets based on the target node being in a same chiplet as a chiplet of a sender node.

11. The method of claim 9, comprising:
selecting a first router to route the packets based on the target node being a first node span from a sender node.

12. The method of claim 11, comprising:
selecting a port to a second router to route the packets based on the target node being a second node span from a sender node, wherein the second node span is greater than the first node span.

13. The method of claim 9, comprising:
processing the packets at the target node after receiving the packets.

14. The method of claim 9, comprising:
transmitting the packets using a signal and wherein a frequency of the signal is based on a number of hops that the packets traverse.

15. An apparatus comprising:
a device comprising:
a first trace that comprises a link that connects nodes separated by A number of nodes of a plurality of nodes and
a second trace that comprises a link that connects nodes separated by B number of nodes of the plurality of nodes, where B is greater than A, wherein:
a node of the plurality of nodes comprises a processor, memory, and a router, and
the router is communicatively coupled to the first trace and the second trace.

16. The apparatus of claim 15, wherein the node of the plurality of the nodes comprises multiple communicative couplings among circuitry of the node.

17. The apparatus of claim 16, wherein:
the router is communicatively coupled to the first trace, the second trace, and at least one of the multiple communicative couplings.

18. The apparatus of claim 15, wherein:
the device comprises multiple layers,
a first set of the multiple layers includes the first trace, and
a second set of the multiple layers includes the second trace.

19. The apparatus of claim 16, wherein:
a configuration is to specify routing of communications between multiple nodes of the plurality of nodes from among the first trace, the second trace, or a communicative coupling of the multiple communicative couplings.

20. The apparatus of claim 15, wherein the router is to receive a signal and wherein a frequency of the signal is based on a number of hops that the signal traverses.
